(19) United States
(12) Patent Application Publication
(10) Pub. No.: US 2002/0062926 A1
(43) Pub. Date: May 30, 2002

(54) Resin composition with excellent dielectric property

(75) Inventors: Hsien-Yin Tsai, Tainan (TW); Joung-Yei Chen, Hsinchu (TW); Hsi-Hsin Shih, Taichung (TW); Chi-Lan Li, Taichung Hsien (TW); Wei-Han Liao, Hsinchu City (TW)

Correspondence Address: DARBY & DARBY P.C., 805 Third Avenue, New York, NY, 10022, US

(73) Assignee: Industrial Technology Research Institute

(21) Appl. No.: 09/859,032

(22) Filed: May 16, 2001

(30) Foreign Application Priority Data
Oct. 6, 2000 (TW) 89120863

(51) Int. Cl. B32B 31/20

(52) U.S. Cl. 156/309.6; 156/330

(57) ABSTRACT

A resin composition with a low dielectric constant comprises: (a) a functionalized cyclic olefin copolymer; (b) a mixture of epoxy resins; and (c) a curing agent. A laminate and a resin coated clad made of the resin composition exhibit reduced dielectric constants of 3.3 and 2.9 at 1 GHz, respectively.

### BACKGROUND OF THE INVENTION

1. Field of the Invention

The present invention relates to a resin composition. In particular, the present invention relates to a resin composition with a low dielectric constant (Dₖ) for electric circuit boards.

2. Description of the Related Art

Printed circuit boards (PCBs) are essential components of electronic products. The PCBs can be divided into two types based on their utility, one is PCB for information, and the other is PCB for communication.

To the PCB for information, a mass data and information should be treated, and it brings a great quantity of thermal energy. Therefore, a substrate with heat-resistant and low dielectric constant is the trend of future development. Recently, the substrate is primarily laminated with thermoset epoxy resin, and it can reach the requirements of heat-resistance, that is its glass transition temperature (T_{g}) is over 160° C., but it is hard to reach the requirements of a low dielectric constant. Some people mix the epoxy resin with polyphenyl oxide (PPO) to reduce the dielectric constant of the substrate. Although the dielectric constant is decreased by using this method, the solvent-resisting and heat-resisting of the substrate are sacrificed.

To the PCB for communication, it need high frequencies to enhance the signal-transmitting speed and distance. Therefore, the substrate with low dielectric constant (Dₖ) and low dissipation factor (D_{f}) is the trend of future development. Recently, the primary material of the substrate is thermoplastic polytetrafluoroethylene (PTFE). The PTFE has excellent electrical properties, but its glass transition temperature (T_{g}) is only about 30° C. When a mass information is transmitted on the PTFE substrate, a lot of heat is produced so that the PTFE substrate is softened and loses its good electrical properties. Furthermore, the PTFE is expensive, peeling strength with copper is insufficient, and processing processes to be the PCB are not easy.

In order to match up the integrated trade of future information technology and communication technology, high heat-resistance and a low dielectric constant are the essential properties of the substrate.

The cyclic olefin copolymer (COC) has a relatively low dielectric constant, thus it is easy for some people using it to fabricate of expoxy substrate. However, the reactivity of the COC is so bad, so some people provide a method to produce COC free radical with using peroxide to react with epoxy resin. However, it is difficult to control its molecular weight.

### SUMMARY OF THE INVENTION

An object of the present invention is to provide a method to fabricate PCB with COC having a low dielectric constant.

Another object of the present invention is to provide a PCB composition comprising COC having a low dielectric constant, and the PCB has the property of heat-resistance.

Another object of the present invention is to provide a resin composition with COC, and the molecular weight of the resin can be controlled in a requested range.

In order to achieve the above-mentioned objects, the COC is functionized by metallocene and cross-linked with epoxy resin mixture to produce a resin whose molecular weight can be controlled within a demanded range.

### DETAILED DESCRIPTION OF THE PRESENT INVENTION

A resin composition with a low dielectric constant of the present invention comprises:(a) a functionalized cyclic olefin copolymer (f-COC) with a functional group; (b) a mixture of epoxy resins; and (c) a curing agent. A detailed description of each component will be given hereafter.

The content of the f-COC in the component (a) of the resin composition is 0.01-99.9 parts by weight based on the resin composition. The f-COC is obtained by functionalizing a cyclic olefin copolymer (COC). The COC comprises the following three types:

(1) a COC with unsaturated double bonds synthesized by monomers (A), (B) and (C); or

(2) a COC with alkylstyrenes synthesized by monomers (A), (B) and (D); or

(3) a COC with unsaturated double bonds and alkylstyrenes synthesized by monomers (A), (B), (C) and (D).

The above-mentioned monomers (A), (B), (C) and (D) are described as following.

monomer (A) : a cyclic olefin comprising one of the following formulas from I to VII.

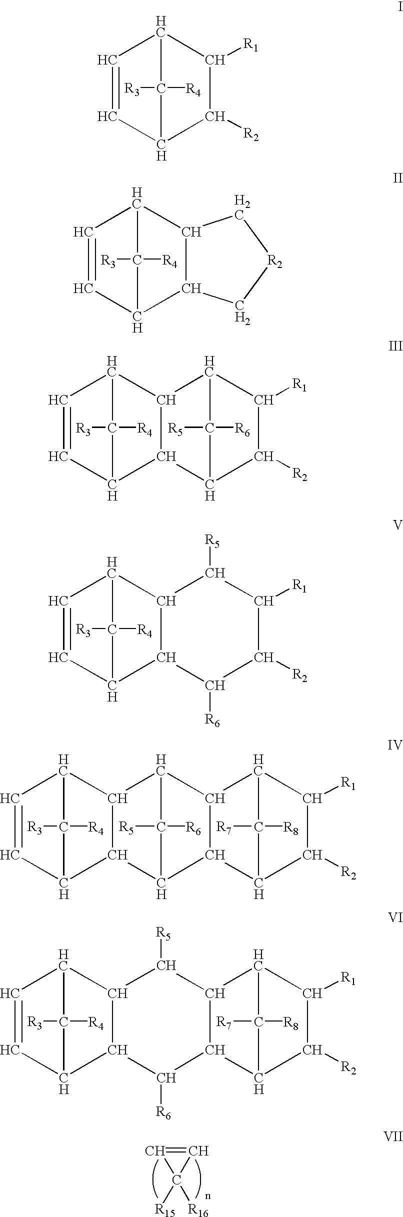

In the formulas I to VII, R₁ and R₂ can be the same or different and are selected from the group consisting of hydrogen, halogen, C₁-C₁₀ alkyl, haloalkyl, aryl, and haloaryl; R₃, R₄, R₅, R₆, R₇ and R₈ can be the same or different and are selected from the group consisting of hydrogen, C₁-C₂₀ hydrocarbon group, and C₁-C₂₀ cyclic group; R₁₅ and R₁₆ can be the same or different and are selected from the group consisting of hydrogen, halogen, C₁-C₁₀ alkyl, and haloalkyl; n is an integer from 2 to 10.

monomer (B): a cyclic olefin comprising one of the following formulas from VIII to XII.

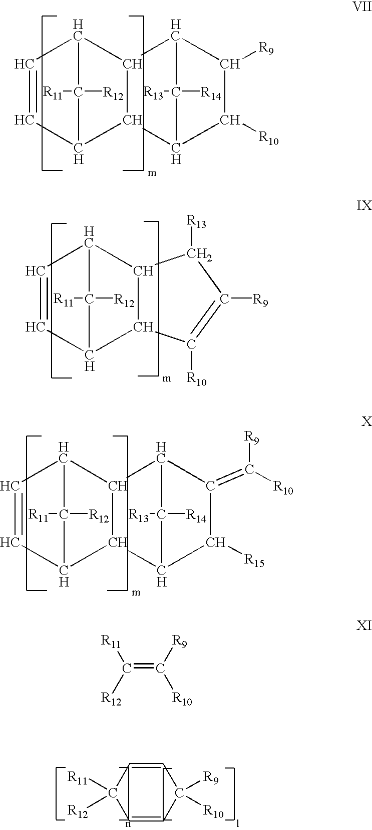

Each formula from VIII to XII has at least one cyclic olefin with at least one double bond. R₉, R₁₀, R₁₁, R₁₂, R₁₃, R₁₄ and R₁₅ can be the same or different and are selected from the group consisting of hydrogen, C₁-C₈ alkyl, C₆-C₁₄ aryl, and C₃-C₁₅ alkenyl. R₉, R₁₀, R₁₁, R₁₂, R₁₃, R₁₄ and R₁₅ in formulas VIII and XI comprise at least one double bond. m is an integer from 0 to 10. n and l are integers from 0 to 10, but cannot be 0 at the same time.

monomer (C): C₂-C₂₀ α olefin.

monomer (D): an alkylstyrene comprising the following formula XIII.

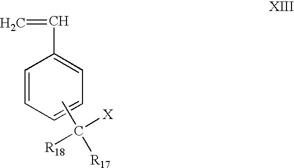

In the formula XIII, R₁₇ and R₁₈ are independently selected from the group consisting of hydrogen, alkyl, primary and secondary haloalkyl, and X is (1) hydrogen, (2) halogen, (3) functional group, (4) a polymer moiety, (5) alkaline metal or alkaline-earth metal, and (6) the combinations thereof.

Whether or not in the COC with unsaturated double bonds [synthesized by monomers (A), (B) and (C)], or the COC with alkylstyrene [synthesized by monomers (A), (B) and (D)], or COC with unsaturated double bonds and alkylstyrene [synthesized by monomers (A), (B), (C) and (D)], after functionalizing, they contain the same or different heteroatoms, such as hydrogen, halogen, carbon, oxygen, nitrogen, sulfur, phosphorus, selenium, silicon, tin and so on, epoxide, halogen, hydroxy, sulfate, boron, aldehyde, ketone, a polymer moiety and the like. The branch polymerization can happen in the unsaturated double bonds and alkylstyrene groups to produce the COC with the polymer moiety. The polymer moiety can be a monomer which can polymerize with the COC by an anion or a cation, a monomer which can open-ring polymerize with the COC by an anion or a cation, or a monomer which can polymerize by radical. The polymer moiety also can be a nucleophile comprises a functional polymeric nucleophile having sufficiently nucleophilic such that said nucleophile is capable of displacing the halogen from the benzyl halide.

The above-mentioned epoxide comprises a functional group such as —R, —ROH, —OH, —OR, —NH₂ or the like, wherein R is alkyl, and the hydrogen in R can be totally or partially replaced in halogen. The epoxide can be glycidyl ether, methacrylic acid glycidyl ether, glycidyl methacrylate, acrylic acid glycidyl ether, or combinations thereof.

The preferred founctionalized COC in the component (a) is a epoxy COC. The method of producing the epoxy COC comprises: copolymerizing α-olefin, norbornene and diene under catalyzing with a metallocene to produce a COC with unsaturated double bonds; and functionalizing the unsaturated double bonds of the COC to produce the epoxy COC. The other method of producing the epoxy COC comprises: copolymerizing α-olefin, norbornene and alkylstyrene under catalyzing with a metallocene to produce a COC with alkylstyrenes; and functionalizing the alkylstyrenes of the COC to produce the epoxy COC. The weight-average molecular weight of the epoxy COC is 1×10³ to 5×10³.

The above-mentioned, final reaction, functionalizing the unsaturated double bonds of the COC to produce the epoxy COC, or functionalizing the alkylstyrenes of the COC to produce the epoxy COC, can be conducted by meta-chloroperoxybenxoic acid (mCPBA).

The content of the mixture of epoxy resins in the component (b) of the resin composition is 0.01-99.99 parts by weight based on the resin composition. It comprises: (b₁) 10-90 parts by weight (based on the mixture of epoxy resins) of a bisphenol polyglycidyl ether; and (b₂) 10-90 parts by weight (based on the mixture of epoxy resins) of a epoxidized novolak resin.

The bisphenol polyglycidyl ether in the component (b₁) has the following formula:

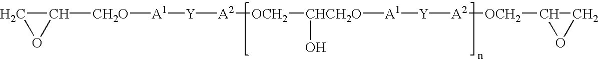

wherein each of A¹ and A² is a monocyclic divalent aryl, and Y is a substituted hydrocarbon group used to separating A¹ and A².

The A¹ and A², the monocyclic divalent aryl, can be unsubstituted phenylene or substituted derivatives. The substituent of the phenylene derivatives includes alkyl, nitro, alkoxy or the like.

Y is a substituted hydrocarbon group, such as methylene, cyclohexylmethylene, ethylene, isopropylidene, neopentylidene, cyclohexylidene, cyclopentadecyidene or the like. The substituent of the substituted hydrocarbon group Y is hydrocarbons, oxygen, sulfoxy, sulfone or the like.

The epoxy equivalent weight of the bisphenol polyglycidyl ether in the component (b₁) is from 160 to 4,000.

The content of the curing agent in the component (c) of the resin composition is 0.01-50 parts by weight based on the resin compostion. The curing agent can be aromatic amine, secondary amine, tertiary amine, acid, anhydride, Dicy or the like.

Furthermore, the resin composition can further comprise a curing accelerating agent, such as boron trifluoride-amine complex, to accelerate the hardening rate of the circuit boards.

In the present invention, the above-mentioned resin composition is mixed completely to become a varnish. A glass cloth is impregnated in the varnish to be a prepreg. Then the prepreg was heated and laminated to a laminate. The dielectric constant (Dₖ) of the laminate is 3.3 (at 1 GHz). The prepreg was compressed with a copper foil to be a CCL with a low dielectric constant. Therefore, the circuit boards provided by the present invention have excellent electrical properties, so that can be applied in information and communication industries.

Moreover, the varnish can be coated on the copper foil. After drying, it becomes a resin coated clad (RCC). The dielectrid constant (Dₖ) of the resin part of the RCC is 2.9 (at 1 GHz).

Without intending to limit it in any manner, the present invention will be further illustrated by the following examples.

### Preparation Example

Preparation of the functionalized cyclic olefin (thereafter is simplified as f-COC)

The Parr reactor was preset at 120° C. and started heating and pumping to vacuum for at least one hour (usually 2 hours). Then nitrogen with high purity (under pressure of about 5 kg/cm²) flowed into the reactor and the supply was exhausted. The injecting nitrogen and exhausting steps were repeated 5-6 times. After that, the reactor was set up at 50° C. and kept under above atmospheric pressure.

100 ml of the mixture of norbornene/5-ethylidene-2-norbornene (ENB)/toluene was used in each batch of reactions. The toluene should be dehydrated by refluxing with Na under nitrogen atmosphere, and the water content should be below 10 ppm.

Methyl aluminoxane (MAO) (1.49M), tetra-isobutyl aluminum (TiBA) (1M) and catalyst are stored in a glove box. The amount of the catalyst is about 0.2 mg/100 ml reactant mixture in polymerization.

The mixture of norbornene/ENB/toluene was pressed into the reactor by canula with nitrogen and the reactor was heated to 100° C. The catalyst solution and MAO were took from the glove box by needles in requested amount and the catalyst solution was injected into the reactor without releasing pressure. Then the pressure of ethylene was adjusted to the reacting pressure, and the polymerization was started. After 30 minutes, the polymerization was terminated with MeOH/HCl. Then the reactor was opened and the toluene was added therein to dilute the reactant mixture. The diluted reactant mixture was poured in acetone to precipitate the polymerization product. The reactant mixture was filtered, washed with acetone, extracted by Soxhlet extraction method for 24 hours, and dried under vacuum oven to afford the copolymer. From ¹H-NMR spectrum, the peak representing the unsaturated olefin group was observed at 5.2 ppm.

12.2 g of the copolymer described above was added in 100 ml toluene, and stirred. After the copolymer was dissolved, 1.3 g meta-chloroperoxybenxoic acid (mCPBA) was added, and reacted for 4 hours. The reacted reactant mixture was poured into methanol to precipitate the epoxy cyclic olefin copolymer (epoxy COC) product. The epoxy COC product was washed with acetone and dried. From the ¹H-NMR spectrum, the peak height of the peak which was observed at 5.2 ppm and represents the unsaturated olefin group was decreased, and the peak representing the epoxy group was observed at 3.0 ppm.

The epoxy COC was added in 100 ml cyclohexane. Then 36 ml CF₃CH₂OH was added and reacted at 50° C. for 8 hours. The reactant mixture was poured in acetone to precipitate the hydroxyl and fluoro-ether COC product, then the product was dried. From the ¹H-NMR spectrum, the peak which was originally observed at 3.0 ppm and represents the epoxy group shifted to 3.8 ppm which representing the CF₃CH₂O— group.

### EXAMPLES 1-4

Preparation of the mixture of expoxy resins

Bisphenol A (DOW Co.; Cat. No. DER-331) and novolak (DOW Co.; Cat. No. DEN-438) were added to butanone (Aldrich Co.), and stirred for 10-15 min at room temperature to dissolve epoxy resin thoroughly to form a epoxy resins solution.

Preparation of the varnish (or called as colloidal solution)

The f-COC was added to the epoxy resins solution described above, and stirred to dissolve f-COC thoroughly. The curing agent, diamino diphenyl sulfone (DDS), and the curing accelerating agent, boron trifluoride-monoethylamine (BF₃-MEA), were added to the solution described above, and stirred to disperse sufficiently to form a varnish.

Preparation of the prepreg

A prepreg was prepared by impregnating a glass cloth (local company; Cat. No. E-glass, 2116) with the varnish (colloidal solution) described above, and heated in an oven at 90-130° C. for 10-30 min.

Preparation of the laminate

The dried prepreg is subjected to compression molding at 160-320° C. for 180-360 minutes. The laminate thus obtained was measured for the dielectric properties. The results of the measurements are shown as examples 2-4 in Table 1.

Preparation of the copper clad laminate (CCL)

The dried prepreg is subjected to compression molding at 180-360° C. for 180-360 minutes to obtain a CCL.

Preparation of the RCC

The vanish which contains f-COC and the epoxy resins solution was coated on a copper foil by die coating, then subjected to bake in an oven at 90-130 ° C. for 180-360 minutes to obtain a RCC. After the RCC is etched, then the etched RCC was measured for the dielectric properties. The result of the measurements are shown in Table 1.

TABLE 1
The dielectric constants of electric circuit boards
made from different composition.

| | | | | Curing | | | |
|---|---|---|---|---|---|---|---|
| | Mixture of | f-COC | Curing | accelerating | Glass | Copper | Dielectric |
| | epoxy resins | [1] | agent | agent | cloth | foil | constant (1 GHz) |
| Example 1 | 100^{[2]} | 100^{[2]} | 30^{[2]} | 1^{[2]} | — | + | 2.9 |
| Example 2 | 100 | 100 | 30 | 1 | + | — | 3.3 |
| Example 3 | 100 | 100 | 30 | — | + | — | 3.8 |
| Example 4 | 100 | 20 | 30 | 1 | + | — | 3.5 |
| Comparative | 100 | — | 30 | 1 | + | — | 4.5 |
| example 1 | | | | | | | |
| Comparative | — | 100 | — | — | — | — | 2.4 |
| example 2 | | | | | | | |

^{[1]} f-COC is a functionalized cyclic olefin produced under catalyzing with a metallocene.
^{[2]} unit is % by weight.

As can be seen from Table 1, the dielectric constant (Dₖ) of the resin part of the RCC is 2.9 (at 1 GHz). The dielectric constant (Dₖ) of the laminate can be reduced to 3.3 (at 1 GHz) as compared with traditional laminate whose dielectric constant (Dₖ) is 4.5 at 1 GHz. The RCC and laminates of the present invention have relatively low dielectric constants. Therefore, the circuit boards provided by the present invention have excellent electrical properties, that can be applied in information and communication industries.

Finally, while the invention has been described by way of examples and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A resin composition with a low dielectric constant, comprising:
(a) 0.01-99.99 parts by weight (based on the resin composition) of a functionalized cyclic olefin copolymer (COC) with a functional group;
(b) 0.01-99.9 parts by weight (based on the resin composition) of a mixture of epoxy resins; and
(c) 0.01-50 parts by weight (based on the resin composition) of a curing agent.

2. The resin composition as claimed in claim 1, wherein the founctionalized COC in is obtained by functionalizing a COC, wherein the COC comprising:
(1) a COC with unsaturated double bonds synthesized by monomers (A), (B) and (C); or
(2) a COC with alkylstyrenes synthesized by monomers (A), (B) and (D); or
(3) a COC with unsaturated double bonds and alkylstyrenes synthesized by monomers (A), (B), (C) and (D), wherein
monomer (A): a cyclic olefin comprising one of the following formulas from I to VII 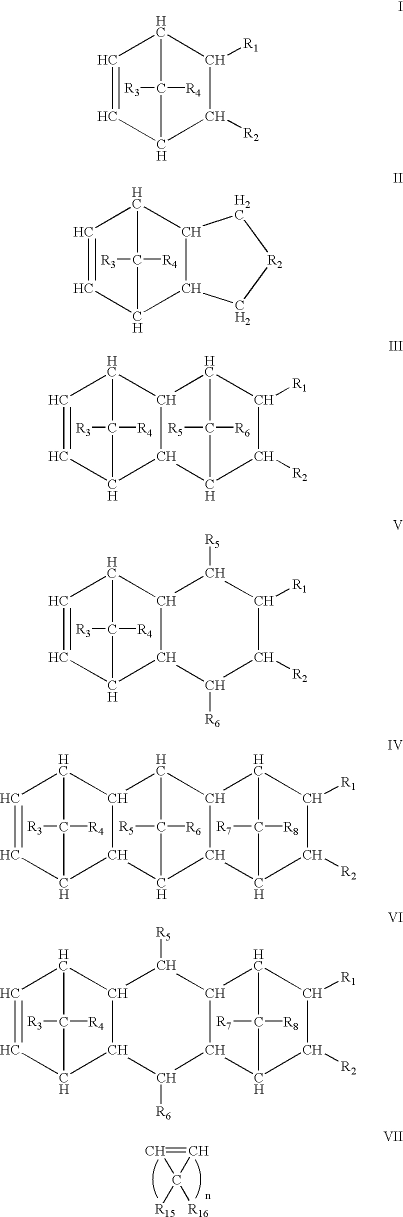
wherein
R₁ and R₂ can be the same or different and are selected from the group consisting of hydrogen, halogen, C₁-C₁₀ alkyl, haloalkyl, aryl, and haloaryl,
R₃, R₄, R₅, R₆, R₇ and R₈ can be the same or different and are selected from the group consisting of hydrogen, C₁-C₂₀ hydrocarbon group, and C₁-C₂₀ cyclic group,
R₁₅ and R₁₆ can be the same or different and are selected from the group consisting of hydrogen, halogen, C₁-C₁₀ alkyl, and haloalkyl, and
n is an integer from 2 to 10,
monomer (B): a cyclic olefin comprising one of the following formulas from VIII to XII 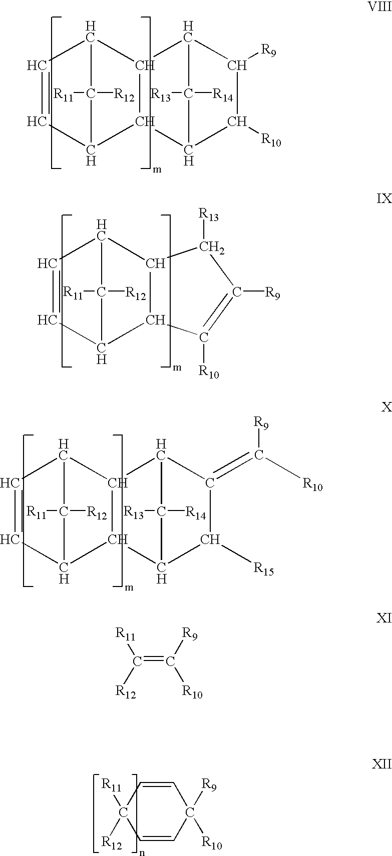
wherein
each formulas from VIII to XII has at least one cyclic olefin with at least one double bond,
R₉, R₁₀, R₁₁, R₁₂, R₁₃, R₁₄ and R₁₅ can be the same or different and are selected from the group consisting of hydrogen, C₁-C₈ alkyl, C₆-C₁₄ aryl, and C₃-C₁₅ alkenyl,
R₉, R₁₀, R₁₁, R₁₂, R₁₃, R₁₄ and R₁₅ in formulas VIII and XI comprise at least one double bond,
m is an integer from 0 to 10, and
n and l are an integer from 0 to 10, but cannot be 0 at the same time,
monomer (C): C₂-C₂₀ α olefin
monomer (D): an alkylstyrene comprising the following formula XIII 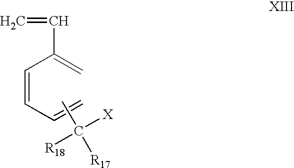
wherein
R₁₇ and R₁₈ are independently selected from the group consisting of hydrogen, alkyl, primary and secondary haloalkyl, and
X is (1) hydrogen, (2) halogen, (3) functional group, (4) a polymer moiety, (5) alkaline metal or alkaline-earth metal, and (6) the combinations thereof.

3. The resin composition as claimed in claim 1, wherein the functional group of the functionalized COC in the component (a) is selected from the group consisting of hydrogen, halogen, carbon, oxygen, nitrogen, sulfur, phosphorous, selenium, silicon, tin, epoxide, hydroxyl, sulfate group, boron, acetaldehyde, ketone, a polymer moiety, and combinations thereof.

4. The resin composition as claimed in claim 3, wherein the epoxide comprises a functional group which is selected from the group consisting of —R, —ROH, —OH, —OR, and —NH₂.

5. The resin composition as claimed in claim 4, wherein the epoxide is selected from the group consisting of glycidyl ether, methacrylic acid glycidyl ether, glycidyl methacrylate, acrylic acid glycidyl ether, and combinations thereof.

6. The resin composition as claimed in claim 1, wherein the functional group of the functionalized COC in the component (a) is an epoxy COC.

7. The resin composition as claimed in claim 6, wherein the method of producing the epoxy COC comprises:
copolymerizing α-olefin, norbornene and diene or alkylstyrene under catalyzing with a metallocene to produce a COC with unsaturated double bonds or alkylstyrenes; and
functionalizing the unsaturated double bonds or the alkylstyrenes of the COC to produce the epoxy COC.

8. The resin composition as claimed in claim 7, wherein the step of functionalizing the unsaturated double bonds or the alkylstyrenes of the COC to produce the epoxy COC is conducted by mCPBA.

9. The resin composition as claimed in claim 7, wherein the weight-average molecular weight of the epoxy COC is 1×10³ to 5×10³.

10. The resin composition as claimed in claim 1, wherein the mixture of epoxy resins in the component (b) comprises:
(b₁) 10-90 parts by weight (based on the mixture of epoxy resins) of a bisphenol polyglycidyl ether; and
(b₂) 10-90 parts by weight (based on the mixture of epoxy resins) of a epoxidized novolak resin.

11. The resin composition as claimed in claim 10, wherein the epoxy equivalent weight of the bisphenol polyglycidyl ether in the component (b₁) is from 160 to 4,000.

12. The resin composition as claimed in claim 10, wherein the bisphenol polyglycidyl ether in the component (b₁) has the 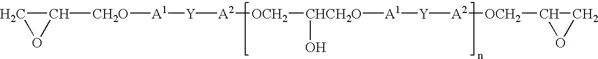
following formula:
wherein each of A¹ and A² is a monocyclic divalent aryl, and Y is a substituted hydrocarbon group used to separating A¹ and A².

13. The resin composition as claimed in claim 1, wherein the curing agent is selected from the group consisting of aromatic amine, secondary amine, tertiary amine, acid, anhyride, and Dicy.

14. A fabrication method of a copper clad laminate (CCL), comprising:
impregnating a glass cloth with the resin composition as set forth in claim 1 to be a preprag; and
compressing the preprag with a copper foil to be the CCL.

15. A fabricating method of a resin coated clad, comprising:
coating a copper foil with the resin composition as set forth in claim 1.
